(19) United States
(12) Patent Application Publication
(10) Pub. No.: US 2016/0271876 A1
(43) Pub. Date: Sep. 22, 2016

(54) Apparatus and method of embedding cable in 3D printed objects

(71) Applicant: Robert Bruce Lower, Chagrin Falls, OH (US)

(72) Inventor: Robert Bruce Lower, Chagrin Falls, OH (US)

(21) Appl. No.: 14/706,695

(22) Filed: May 7, 2015

Related U.S. Application Data
(60) Provisional application No. 62/136,626, filed on Mar. 22, 2015.

(51) Int. Cl. B29C 67/00

(52) U.S. Cl. CPC B29C 67/0081; B29C 67/0055; B29C 67/0088; B29K 2995/0005; B29L 2031/3425

(57) ABSTRACT

Additive manufacturing method and apparatus for embedding cable in articles of additive manufacture in cooperation with a filament extrusion nozzle to increase their strength and functionality. This capability can be provided autonomously by integrating cable guides and cable cutters with new or existing print heads, enabling them to transition between filament-only, cable-only, and combined cable and filament printing modes to form mechanically stronger objects, integrated circuits within objects, and cable alternatives to filament scaffolding.

### FIELD OF THE INVENTION

The present invention relates to additive manufacturing generally, and more particularly, a method of embedding cable in 3D printed objects in cooperation with a filament extrusion nozzle.

### DESCRIPTION OF RELATED ART

In additive manufacturing, it is often advantageous to extrude more than one type of material for greater aesthetic appeal or function. These efforts have largely focused on the integration of filaments with different aesthetic and functional properties, such as colored and electrically conductive filament. While multi-color dual extrusion print heads have proven reliable and desirable, attempts at repurposing filament to embody the functional properties of other materials have experienced limited success, sharply increased costs, and impaired functionality relative to the materials they simulate. It is a purpose of this invention to provide a reliable and affordable system for integrating readily available cable with filament in articles of additive manufacture to enhance their strength and functionality.

### SUMMARY OF THE INVENTION

The invention provides novel additive manufacturing techniques and apparatus for embedding cable in articles of additive manufacture. In addition to autonomously transitioning between filament-only, cable-only, and combined cable and filament printing modes, the current invention includes perpetually rotatable print heads with cable feeding and cutting capabilities.

### BRIEF DESCRIPTION OF THE DRAWINGS

FIGS. 1A-C depict a perpetually rotatable cable head mounted on a 3D printer.

FIG. 1D depicts an open cable channel being filled with cable and filament.

FIG. 1E provides a close-up view of the ratchet cutter assembly depicted in FIGS. 1A-C.

FIGS. 2A-F depict underlying components of the perpetually rotatable cable head of FIGS. 1A-E.

FIGS. 2C-D are top plan views of a perpetually rotatable cable head.

FIGS. 2E-F provide bottom plan views of a perpetually rotatable cable head.

FIGS. 3A-B depict a variable depth open cable channel being filled with cable and filament.

FIGS. 4A-C provide perspective views of a helical cable structure being embedded in an object.

FIGS. 5A-C depict a method of embedding cable into objects without dedicated cable feeding hardware.

FIGS. 6A-C depict a notched and ribbed cable channel.

FIGS. 7A-B depict a cable channel with curved and tapered walls.

FIGS. 8A-C depict an open cable channel with notches, flares, and indents.

FIGS. 9A-C depict an asymmetric cable channel and offset cable guide.

FIGS. 10A-D depict cable core filament and a gear-driven cable shear.

FIGS. 11A-D depict a rotatable cable and filament print head.

FIGS. 12A-C depict cable scaffolding.

FIGS. 13A-B depict a method of forming cable scaffolding around hooks.

FIGS. 14A-C depict a solder-extruding head and hollow continuity channel.

FIGS. 15A-B depict a pre-extrusion cable-filament combining head.

FIGS. 16A-B depict a cable-filament combining head with a variable width extrusion nozzle.

FIGS. 17A-B depict a cable-filament combining head with pressure plates.

FIG. 18 depicts a cable heater and cable spline roller.

FIGS. 19A-C depict a sprag clutch cable feed and cutter assembly.

FIGS. 20A-C depict a filament and cable print head with a cable shear and retractable extrusion nozzle.

FIGS. 21A-E depict a filament and cable print head with a drop shear cable guide that is deployed by cable tension.

FIGS. 22A-D depict a drop shear cable guide assembly that is deployed by cable compression.

Note that use of the same reference numbers in different figures indicates the same or like elements.

### DETAILED DESCRIPTION

The apparatus and methods depicted and discussed provide novel additive manufacturing techniques for creating objects from one or more layers, each layer constructed from one or more beads. Beads constitute a section of extruded filament with a width substantially equivalent to the inner diameter of a filament extrusion nozzle at the tip (measured perpendicularly to the direction of travel for variable width nozzles), with a height substantially equivalent to the distance between the extrusion nozzle's tip and the surface onto which it is extruding filament. Beads and layers may contain a wide variety of cables fed through a cable guide including solid or braided wire, insulated wire, fibers, carbon fiber, and lumens through which any type of fluid may flow. Similarly, any type of filament may be used, including without limitation thermoplastics (e.g., PLA, ABS, HIPS, Nylon), plasticine, fiber-reinforced plastic, concrete, fiber-reinforced concrete, HDPE, rubber, clay, metal clay, and RTV silicone. The process of directing filament and cable to the object being manufactured is often accomplished by running these materials through conduit, a sleeve that is rigid enough to support filament or cable that is being pushed from a remote location, and prevent sharp bends that would encumber the extrusion process. Conduit which never moves may be constructed from rigid materials such as metals, while conduit that needs to flex with the movement of an print head, such as a bowden tube, may be constructed from semi-rigid materials that are flexible enough to accommodate movement, such as polytetrafluoroethylene. Finally, a computer responsible for controlling conventional hardware such as the extrusion nozzle's position and filament extrusion rate ordinarily controls the cable embedding system as well, enabling coordinated motions between the cable and filament systems' shared and independent systems.

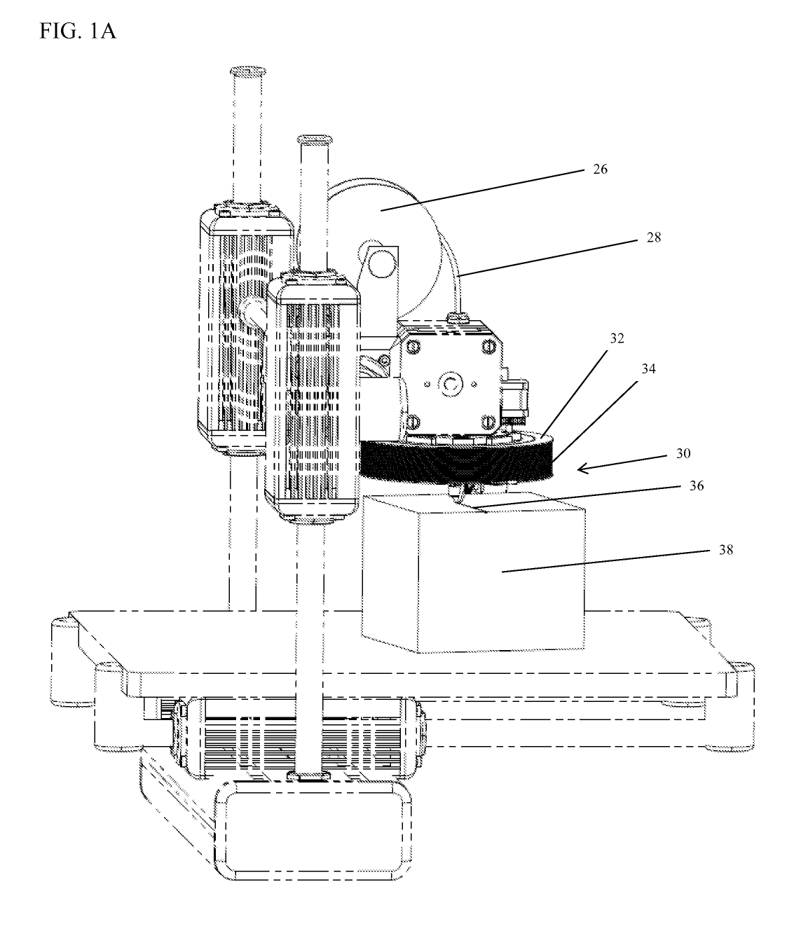

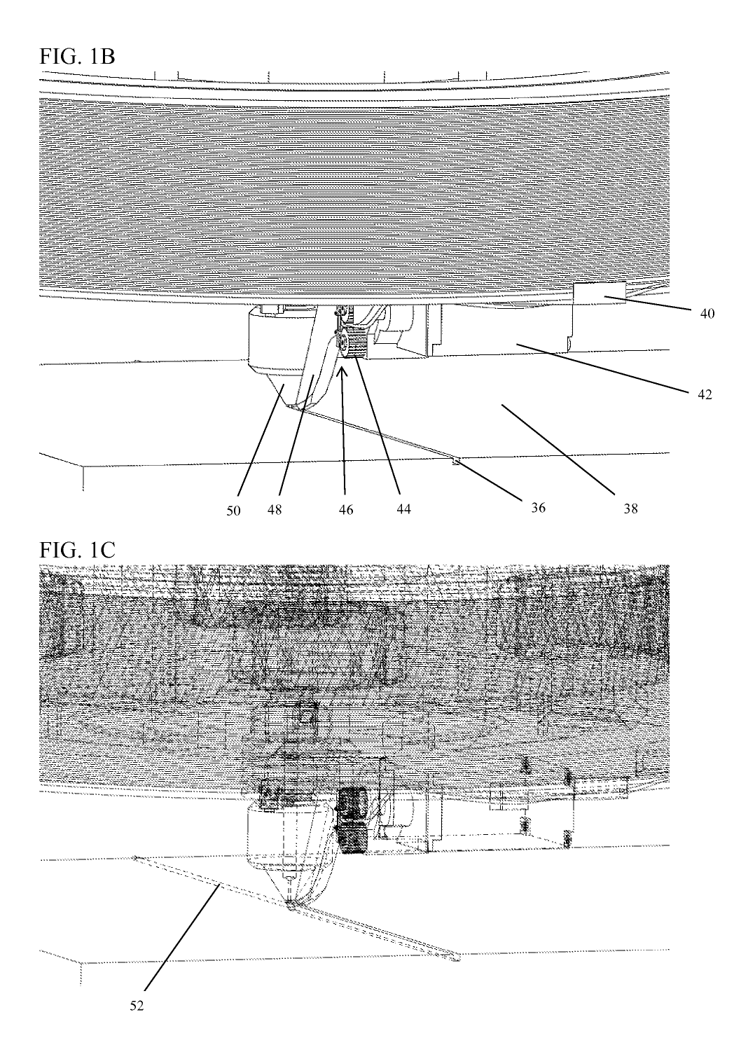

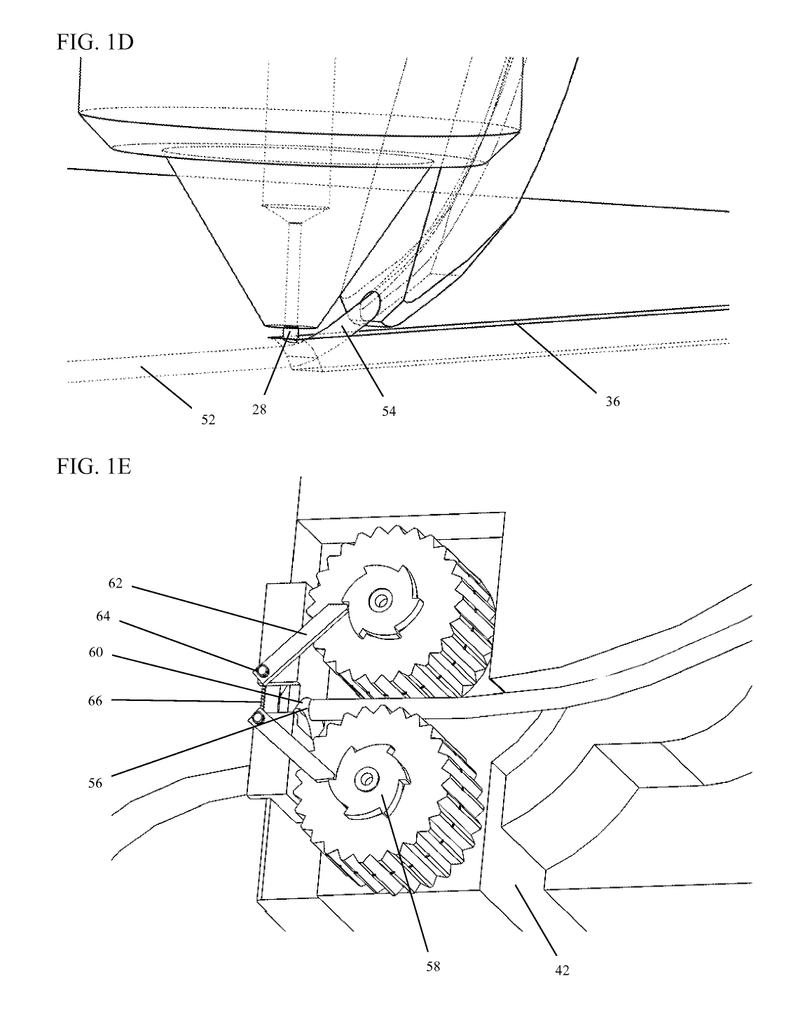

Referring first to FIGS. 1A-C, the operation of the perpetually rotatable cable head on a 3D printer will be most readily understood. FIG. 1A is a perspective view of a conventional 3D printer with a filament spool (26) feeding filament (28) into a typical extrusion nozzle assembly, which has been improved with a perpetually rotatable cable head (30) loaded with a cable spool (32) of wound cable (34) which is being fed into an open cable channel (36) of a simple object (38) constructed from layers of extruded filament.

FIG. 1B provides a close-up perspective view of the perpetually rotatable cable head of FIG. 1A with a spool feed (40), cable feed motor (42), cable drive gears (44), ratchet cutter assembly (46), and cable guide (48) surrounding an extrusion nozzle (50) that is extruding filament into an open cable channel (36) to embed simultaneously fed cable in a simple object being printed (38).

FIG. 1C provides the view of FIG. 1B with hidden lines to expose latent features such as the portion of the cable embedded in the object (52).

FIG. 1D provides a close-up perspective view of the open cable channel (36) of FIGS. 1A-C, within which a section of embedded cable (52) is being formed by contemporaneously extruding filament (28) and cable (54) into the channel.

FIG. 1E provides a close-up perspective view of the ratchet cutter assembly depicted in FIGS. 1A-C showing the end of a cable that has just been cut (56). In this embodiment, the cutter assembly is driven by the cable feed motor (42) via ratchet gears (58) which drive the cutting shears (60) when the cable feed motor (42) is operated in the reverse direction via pushrods (62) whose torsion springs (64) keep them in contact with the ratchet gears once the cutting shears are moved out of the cable's path to their default position by a shear-opening spring (66). While myriad other methods of cutting cable may be used, this and other depicted cutting assemblies generally focus on minimizing weight and the number of power and communication channels that must be maintained between the computer and print head, especially when a perpetually rotatable head is used, as is the case in FIGS. 1A-E.

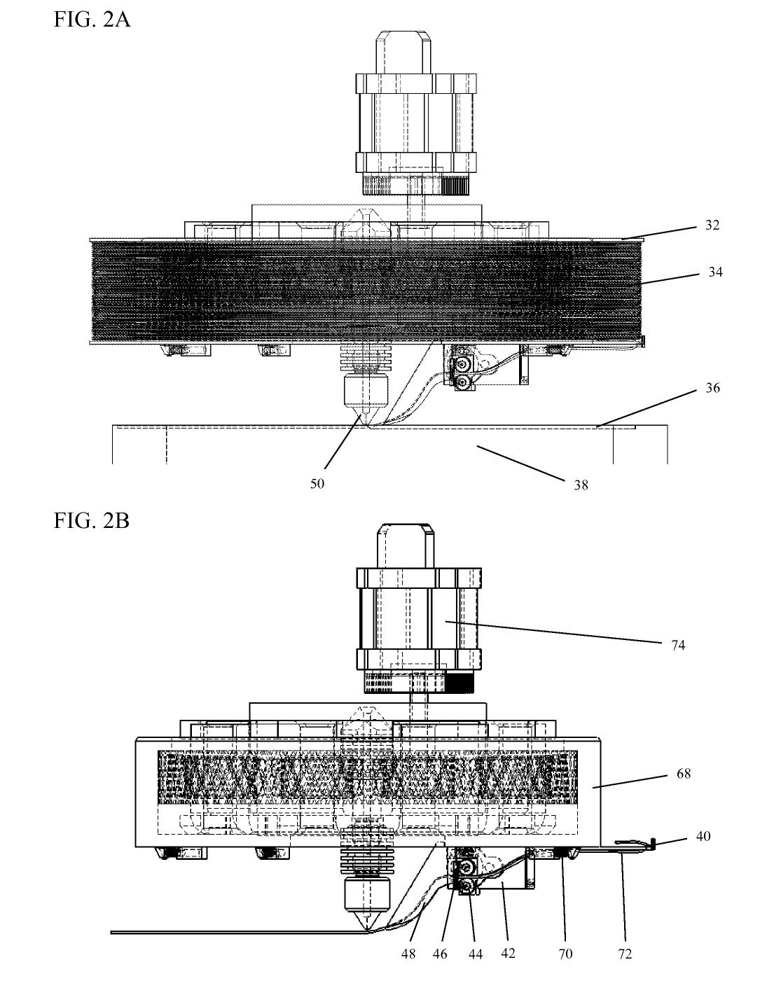

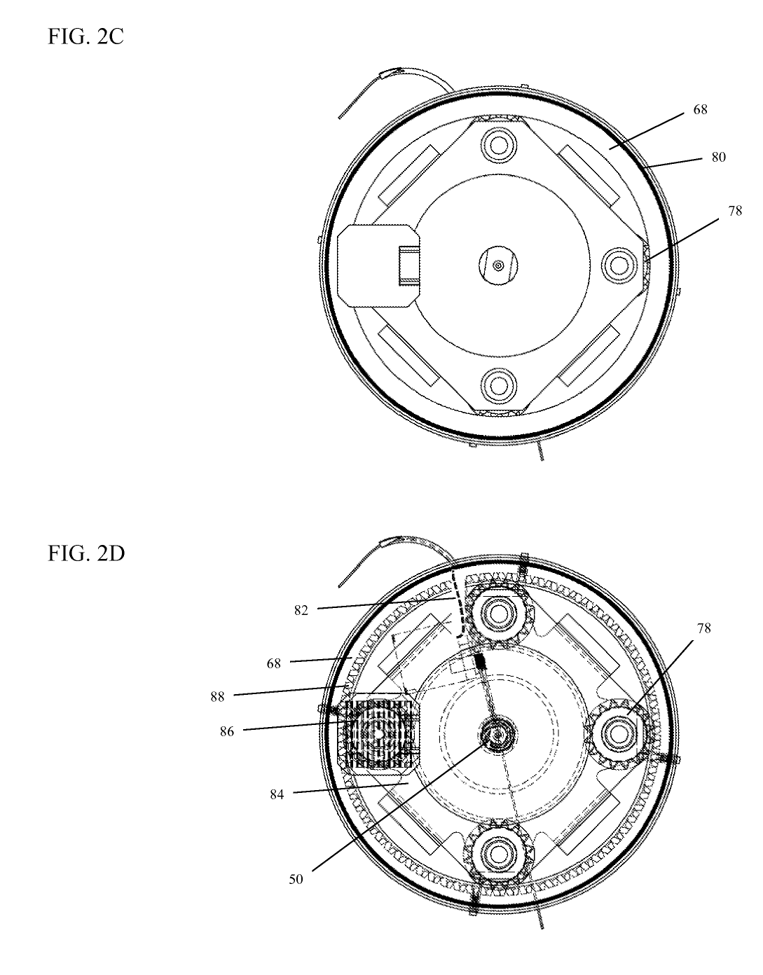

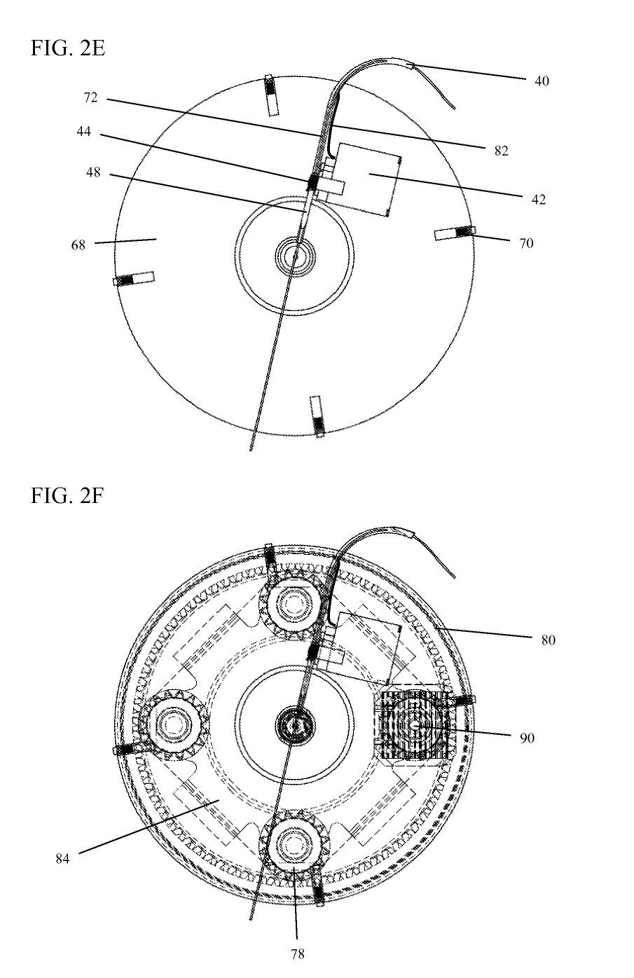

The perpetually rotatable cable head's underlying components are best understood with reference to FIGS. 2A-F. FIG. 2A provides a side elevation view of an extrusion nozzle (50) and perpetually rotatable cable head loaded with a cable spool (32) containing wound cable (34) which is being fed into an open cable channel (36) of a simple object being printed (38).

FIG. 2B provides the side elevation view of FIG. 2A having removed the following to better depict the underlying mechanism of this embodiment: the cable spool, the portion of cable that will not be fed into the channel, and the portion of the simple object formed from extruded filament. The remaining exposed components include an annular cable carriage (68) and several of its peripheral components including spring-loaded spool clips (70), a spool feed (40) which directs cable pulled by a cable feed motor (42) into conduit (72), through which cable travels to cable drive gears (44) pulling the cable, past a ratchet cutter assembly (46), and into a cable guide (48), which directs the cable into the object being printed in a direction corresponding to the angular position of the annular cable carriage. The angular position of the annular cable carriage is set by a cable guide motor (74) such as a stepper motor, depicted in greater detail by FIGS. 2C-F.

FIG. 2C provides a top plan view of the perpetually rotatable cable head from FIG. 2B, revealing additional components including idler gears (78) and a series of slip rings (80) affixed to the top of the annular cable carriage (68) which pick up power and signals from the printer's power supply and computer through fixed contact points slidably connected to the top of the slip rings without regard to the rings' angular position.

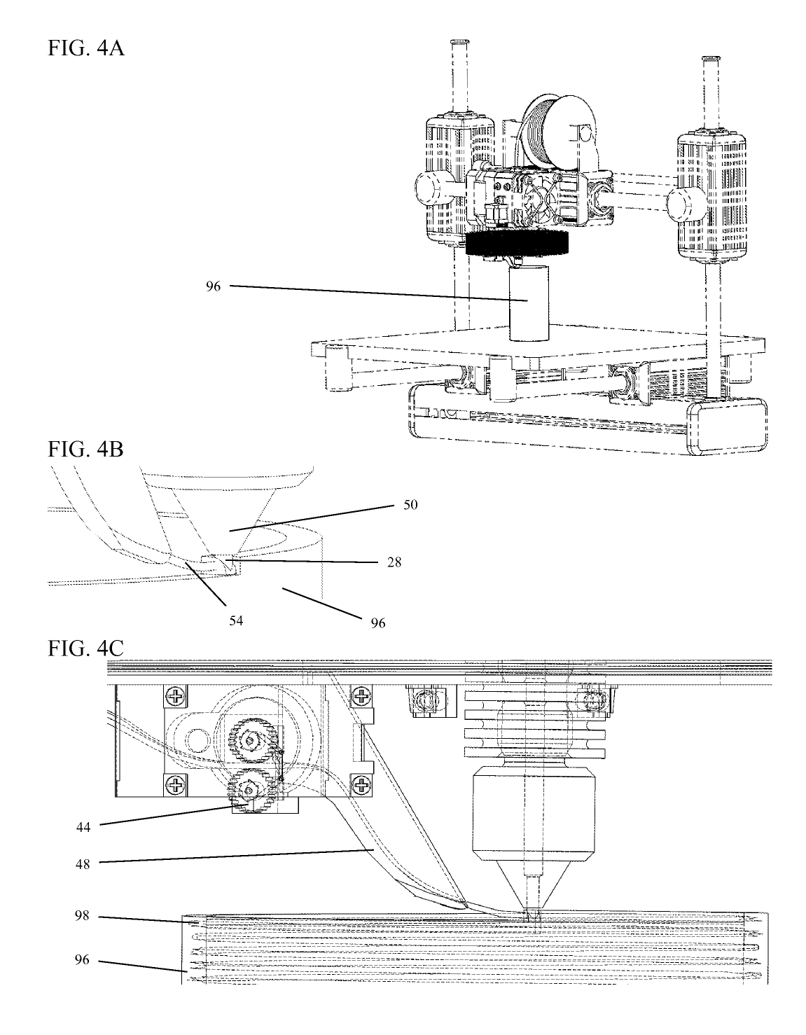

FIG. 2D adds hidden lines to the top plan view presented in FIG. 2C, depicting the slip rings' wiring harness (82) that descends through the annular cable carriage from the slip rings and terminates at the cable feed motor's leads, through which power and signals are transmitted. This arrangement preserves the head's ability to extrude and cut cable in a variety of situations, such as the manufacture of objects that require continual cable guide rotation in a single direction like the helical cable structure depicted in FIGS. 4A-C. FIG. 2D also provides a clear view of the modified epicyclic gear train and carrier upon which this embodiment of the cable head rotates. The main components responsible for enabling perpetual rotation of the annular cable carriage (68) include a carrier frame (84) which can be mounted around, to, or integrated with, an extrusion nozzle (50) that may be fixed or rotatably mounted where a planetary carrier's sun gear would typically appear in this embodiment. The carrier frame's main components include idler gears (78) and a pinion gear (86) in communication with the annular gear face (88) circumferentially imposed upon the inner wall of the annular cable carriage (68), which is supported by, and rotatably coupled to, the carrier frame.

FIG. 2E provides a bottom plan view of the perpetually rotatable cable head from FIG. 2B, providing an additional view of the annular cable carriage (68) and its peripheral components including its wiring harness (82), spring-loaded spool clips (70), spool feed (40), conduit (72), cable feed motor (42), cable drive gears (44), and cable guide (48).

FIG. 2F adds hidden lines to the bottom plan view presented in FIG. 2E to indicate the position of the slip rings (80), carrier frame (84), idler gears (78), and cable guide motor, shaft, and gear assembly (90).

Persons of ordinary skill in the art will realize there are myriad orientations in which the cable cutter and feed motor can be implemented, arranged, powered, and controlled, including belt drives, various gears and gear faces, moving the cable spool to a fixed location under light torque to mitigate slack, wirelessly transmitting indexing commands to stepper motors, grounding the cable feed motor to the frame, and powering the cable feed motor by electrifying conductive cable at the spool.

Without modification, the printer assembly of FIGS. 1A-C can provide several additional advantages such as greater inter-layer shear and tensile strength by manipulating the depth of the embedded cable relative to the extrusion nozzle and cable guide by constructing a variable depth open cable channel and filling it with cable and filament while dynamically adjusting cable and filament discharge rates according to the distance between the cable guide and cable path, as well as the instantaneous cross-sectional area of the channel under the extrusion nozzle's outlet that is neither occupied nor blocked by cable.

The desired depth of embedded cable within an object may vary for a number of reasons ranging from greater inter-layer shear and tensile strength to circumnavigation of hardware or other cables to be embedded in the object. Variable depth cable channels are one way of providing these benefits.

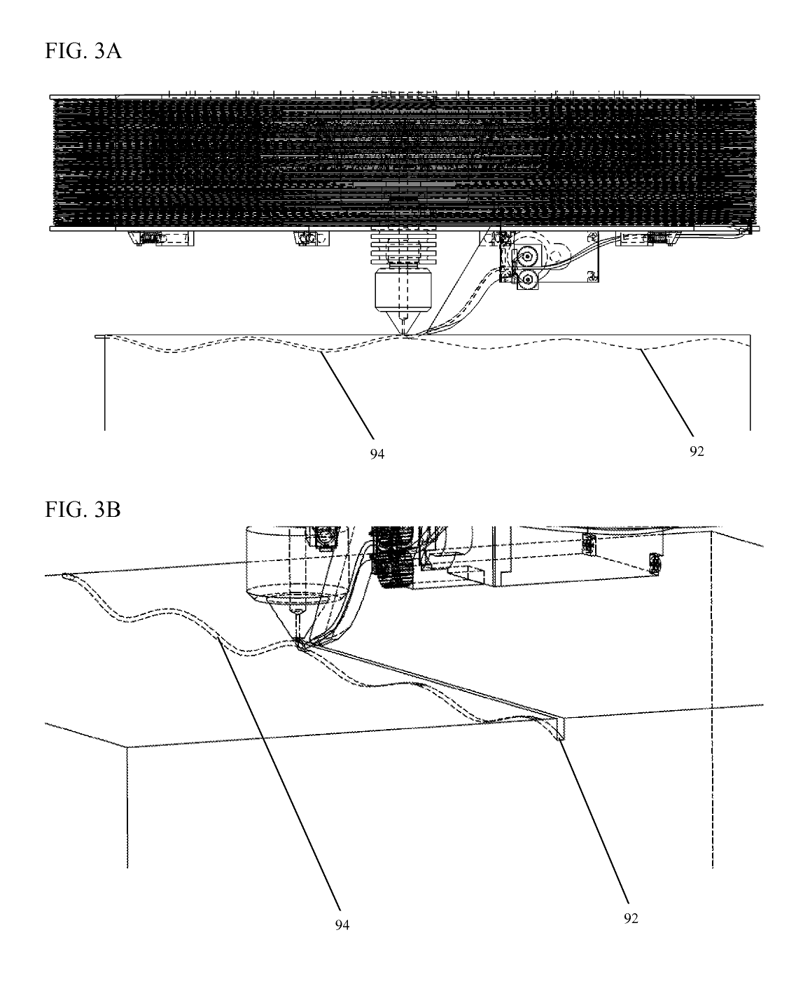

FIG. 3A provides a side elevation view of a variable depth open cable channel (92), within which an oscillating embedded cable (94) is formed by feeding cable and filament into the channel at rates varying with the depth of the channel and speed of the print head.

FIG. 3B provides a perspective view of FIG. 3A's variable depth open cable channel (92) and the oscillating embedded cable (94) formed within the closed portion of the channel.

The sensitivity of polymer-based filaments' viscosity as a function of temperature, and the propensity of changes in distance between the previous print layer and nozzle to cause substantial changes in filament temperature may be mitigated by anticipatorily and dynamically adjusting extrusion nozzle temperature as a function of the upcoming open cable channel depth, the temperature required to properly bind at that depth, the print head speed, the time required to achieve the temperature change, and the multitude of well-known methods for controlling extrusion nozzle temperature such as the use of proportional-integral-derivative control loops. Within the same vein, the process of filling a channel with filament need not occur in a single pass, e.g., layering may be desirable where large quantities of molten filament may cause warping, or where multiple cable runs are embedded in a single channel. Print head speed can be adjusted to compensate for deviation from the target temperature, e.g., by dynamically reducing head speed when an extrusion nozzle thermocouple indicates temperature has failed to increase by the amount commanded.

The cable feed motor can also be slightly overclocked, especially as channel depth increases, to flex the cable slightly and press it against the channel before being embedded by filament, helping to increase the accuracy of cable placement and prevent cable excursion from the channel.

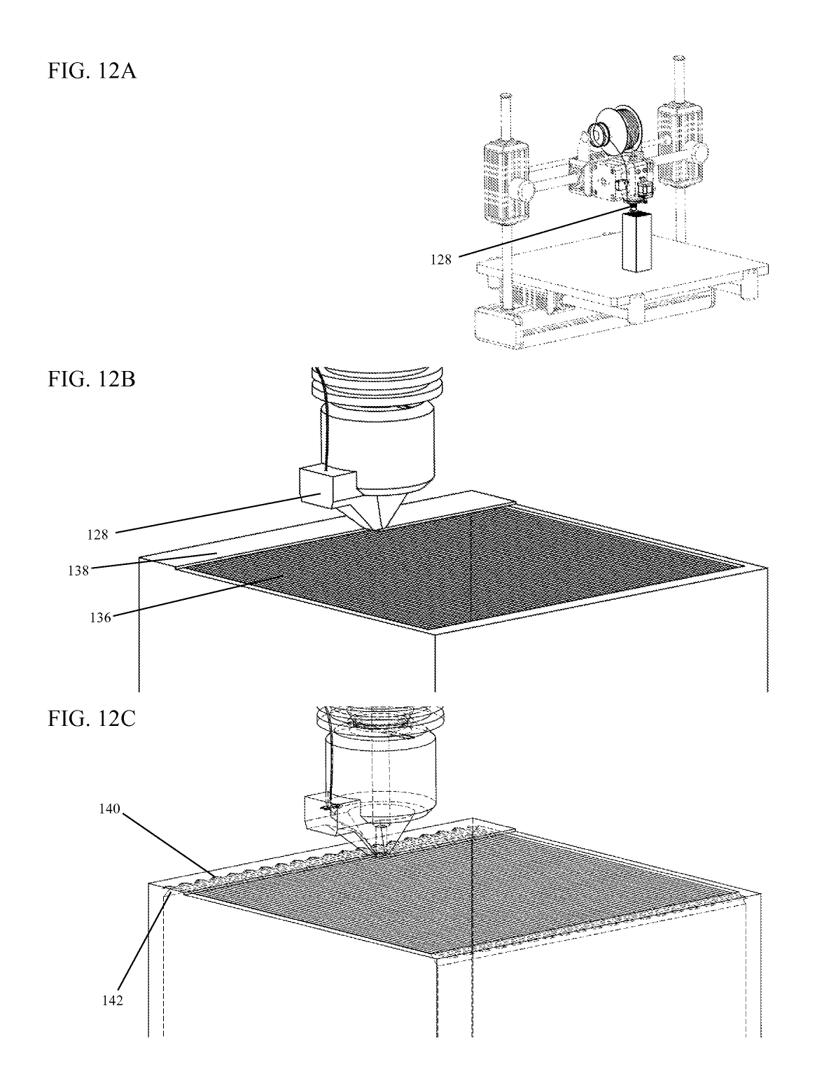

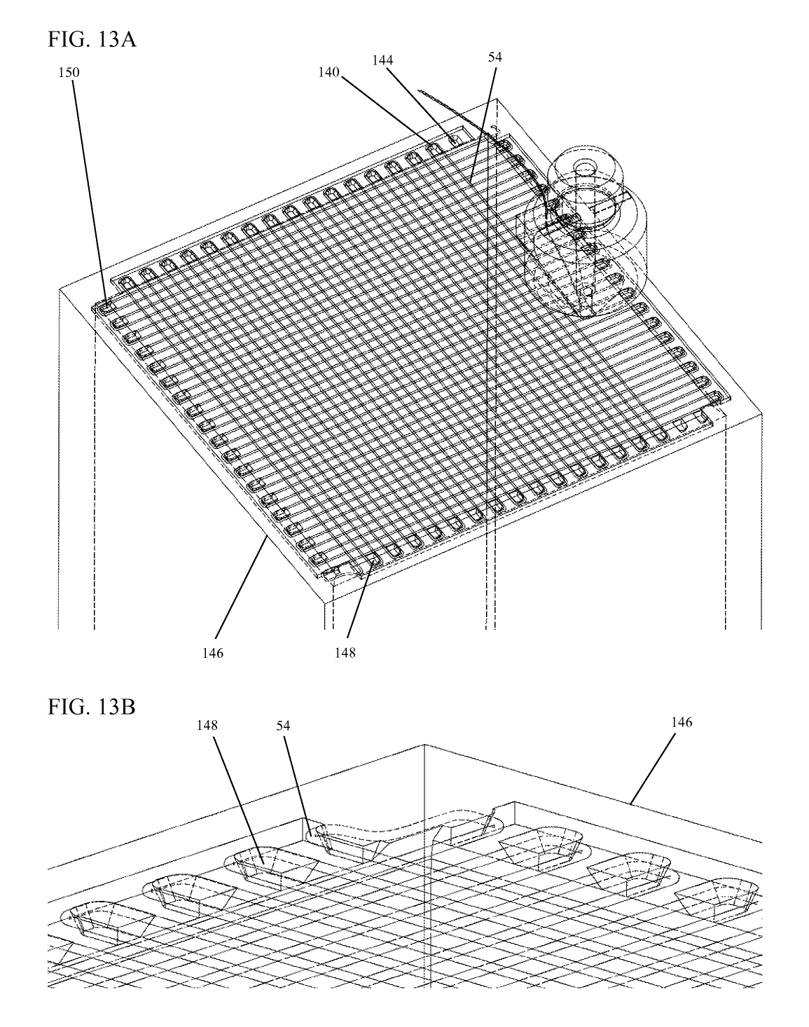

Perpetually rotatable cable heads enable the additive manufacturing of objects whose construction would otherwise be impossible or impracticable because they require continual turns of cable in a single direction, such as inductive coils or helical cable winds. The hollow heated handlebar grip depicted in FIGS. 4A-C provides a simple example of a helical cable structure being embedded in an object, which makes all of its electrical connections in the center of the grip while providing a durable, uniform shell. Furthermore, the top layer (or end of the grip) can be printed perpendicularly across the hollow center of the grip with the cable scaffolding method depicted in FIGS. 12-13. Finally, the top layer may be printed upon cable scaffolding formed from the same piece of cable used in the grip's helical structure where heat (from electrical continuity) is desired on the end of the grip, or, the wire may just as easily be cut before stretching the cable scaffolding when such continuity is not desired.

FIG. 4A provides a perspective view of the perpetually rotatable cable head assembly of FIGS. 1A-E printing a hollow heated handlebar grip (96) with an embedded conductive helical cable.

FIG. 4B provides a close-up perspective view of a hollow heated handlebar grip (96) whose structure is being formed from filament (28) being extruded through an extrusion nozzle (50) over cable (54) being wound into a helical structure.

FIG. 4C provides a side elevation view of a hollow heated handlebar grip (96) with hidden lines depicting the helical cable wind (98) embedded in it, as well as the cable's path through the cable drive gears (44) and cable guide (48). Where a single length of cable must be embedded in a relatively narrow shell structure, as is the case here, the extrusion nozzle can tack back and forth across the cable being fed to prevent undesired cable excursion from the object. Cable guides whose feed direction may be controlled independently of print head movement may provide a greater degree of accuracy in cable placement by feeding cable towards its intended position, even when the print head to which it is attached is moving in a different direction, as is the case in FIGS. 4A-C.

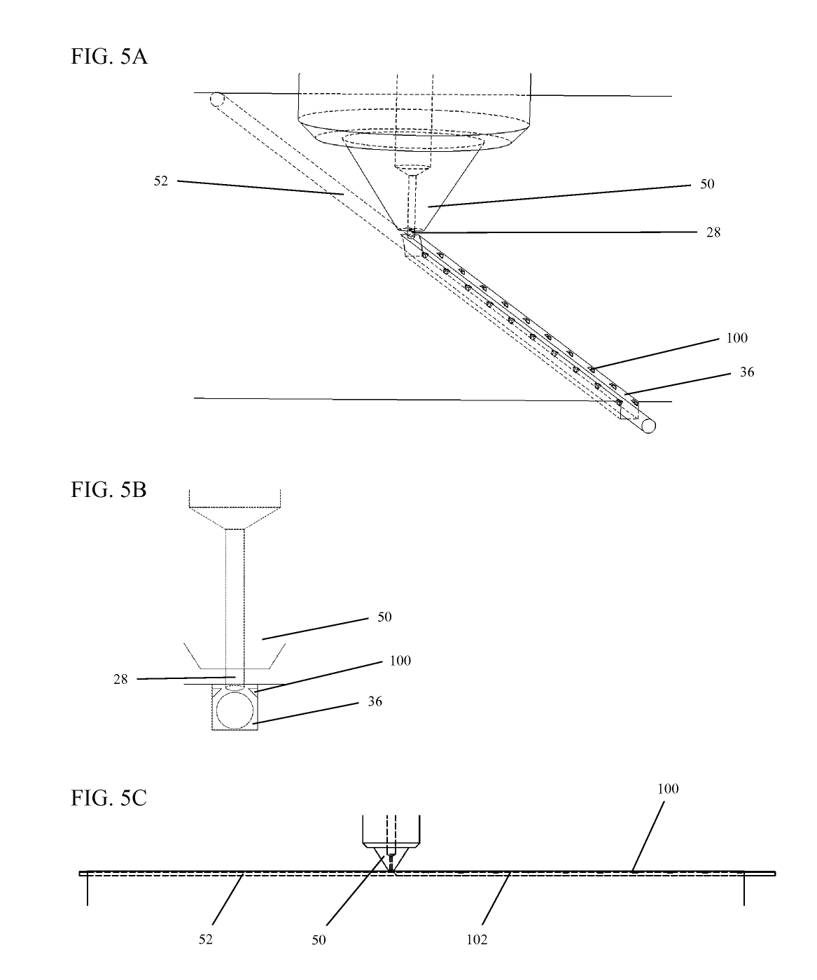

FIGS. 5A-C depict a method of embedding cable into objects by constructing cable channels that can be filled with cable by users or independent cable feeding machinery in lieu of dedicated cable feeding heads.

FIG. 5A provides a perspective view of an object being printed with an open cable channel (36) containing channel notches (100) designed to hold a length of cable that is pressed in from the top or slid in from the side until an extrusion nozzle (50) extrudes filament (28) into the channel to form a length of embedded cable (52).

FIG. 5B provides a side elevation view of the cable channel (36), notches (100), extrusion nozzle (50), and filament (28) of FIG. 5A.

FIG. 5C provides a side elevation view of the embedding process depicted in FIGS. 5A-B including a length of embedded cable (52), extrusion nozzle (50), channel notches (100), and length of unembedded cable (102).

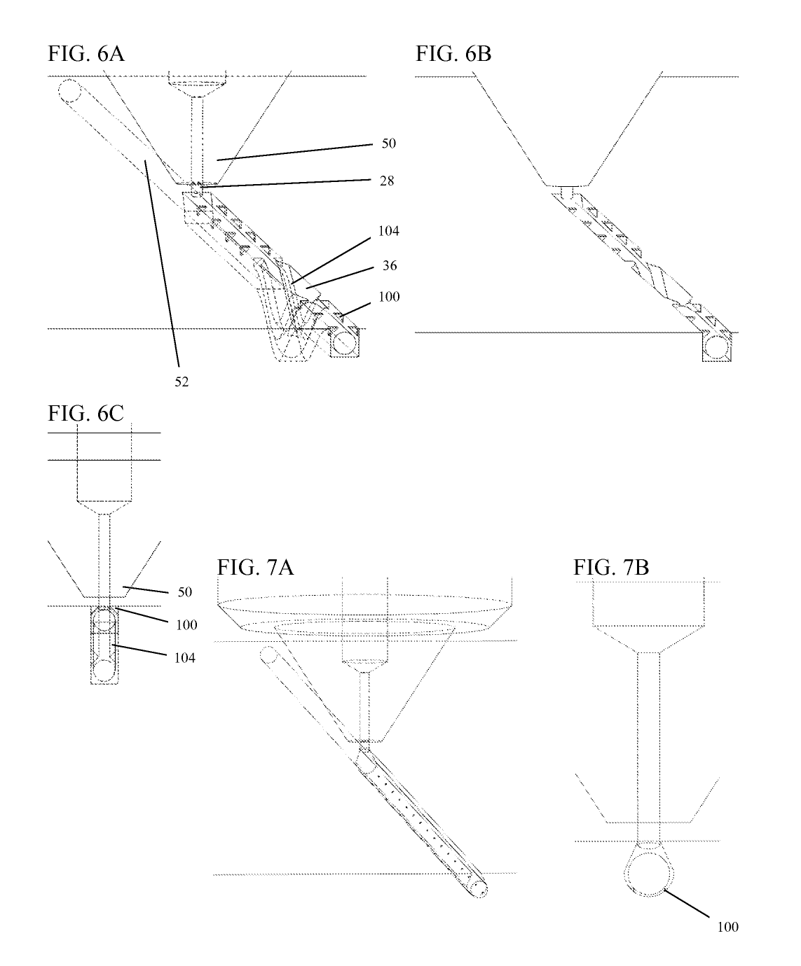

FIGS. 6A-C depict a cable channel similar to that of FIGS. 5A-C with channel ribs to support cable at varying depths permanently or until it is embedded.

FIG. 6A provides a perspective view of an open cable channel (36) supporting a piece of cable that can be positioned by a user, where it is supported by notches (100) and ribs (104) protruding from the channel walls until filament (28) extruded from the extrusion nozzle (50) fills the channel and forms an embedded length of cable (52).

FIG. 6B provides the perspective view of FIG. 6A without hidden lines.

FIG. 6C provides a side elevation view of the ribs (104), notches (100), cable, and extrusion nozzle (50) depicted in FIGS. 6A-B.

For cable pressed into a channel from above, asymmetrical notch and rib distribution along the length of the channel may be desirable, especially where the minimum distance between the protrusions is smaller than the cable's diameter. With an asymmetrical distribution, cable can be flexed into a slight s-curve to clear slalomed notches before reverting to an unflexed state, trapping the cable below the protrusions. In addition to these channel construction methods, and especially when the cable is wider than the extrusion nozzle's output, it is often advantageous to close the channel in two or more passes, sometimes accomplished by first extruding filament along one channel wall to constrict the channel's width over the cable and secure it below.

Cable channel walls may be tapered and curved for a number of reasons, including without limitation formation of channels that can be closed with much less filament than the aforementioned open cable channels. This can provide a number of benefits which vary depending on the type of filament used. For example, in the case of thermoplastics, extruding large volumes of molten filament into open cable channels can cause substantial structural warping, especially in structures using lean infill settings (e.g., 10%). In this and other situations where mitigation of the volume of filament needed to embed cable is desirable, cable channel walls may be formed in a manner that mirrors the cross sectional shape of the cable they are designed to house. FIGS. 7A-B depict this type of channel. Specifically, FIG. 7A provides a perspective view of an open cable channel with walls that are curved and tapered to mitigate the volume of filament required to embed the cable or achieve a higher degree of accuracy in the positioning of the cable.

FIG. 7B provides a close-up side elevation view of FIG. 7A's open cable channel to clearly depict channel wall sections that are curved, tapered, and equipped with notches (100). In this case, the combination of the notches and walls' shape allows extruded filament to circumferentially envelop the cable placed in it. The upper portion of this channel can be constructed in full before cable is fed in from the side, or its upper portion can be constructed around the cable after it has been placed. When even greater mitigation of the amount of filament required to close a channel and embed cable is desired, the tapered walls may be constructed tangentially to the cable such that they form a seal which further reduces the volume of filament required to embed cable.

In additon to the notches, ribs, and various shapes of cable channels, flares and indents providing additional benefits in some cases. When completely embedded cable is not necessary or desireable, flares can ensure secure adhesion points at planned locations by ensuring filaments' ability to circumferentially envelop cable, even when it is firmly pressed against a channel wall.

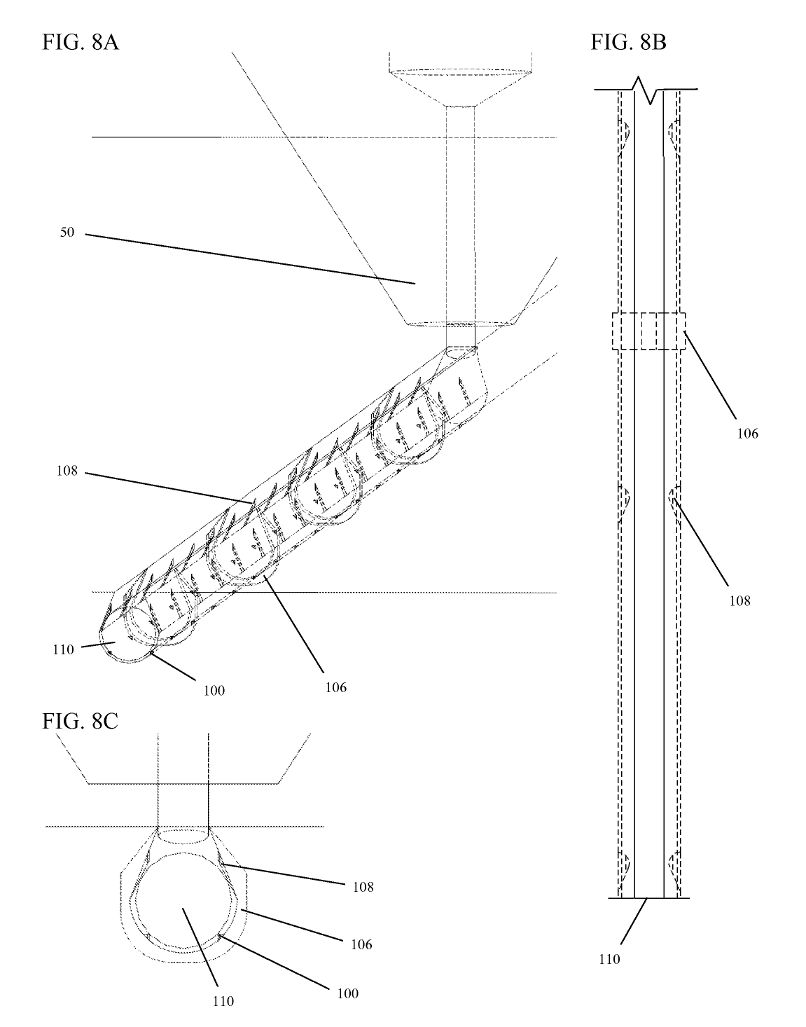

FIG. 8A provides a perspective view of an open cable channel with notches (100), flares (106), and tapered indents (108) within which cable is being secured by filament from an extrusion nozzle (50) moving towards the cable's exposed end (110). The notches and tapered indents hold the cable in a precise location without jeopardizing filament's ability to envelop the cable and form a consistent, level surface over it. Unlike the notches on the lower wall, the tapered indents are larger in size and protrude at a softer angle due to the likelihood of overhang collapse they would present if extruded in the same manner as the notches. Finally, channel flares (106) allow for additional filament to be extruded around the cable with a higher degree of confidence than may be the case in tight tolerance installations or applications where completely embedded cable is undesirable.

FIG. 8B provides a sectional top plan view of the cable's exposed end (110) under the channel's top edge with hiden lines outlining a channel flare (106) and tapered indents (108) whose wedged shape helps guide cable to the center of the channel when slid in from the end (cf., top) of the channel.

FIG. 8C provides a side elevation view of the cable's exposed end (110) in the channel depicted by FIGS. 8A-B including notches (100), tapered indents (108), and flares (106).

While cable channels are generally symmetrical and cable guides are usually closely aligned with extrusion nozzles' direction of travel, in addition to all other channeling methods and hardware, asymmetric channels and offset cable guides can be used independently or together to overcome a multitude of challenges such as preventing cable excursion, increasing head speed, mitigating pre-solidification cable displacement, reducing cable turn radius, and wrapping the exterior of an object with cable.

It also warrants mention that cable guide alignment is often offset only in conjunction with changes in direction such as 180 degree turns and may be used to start bending cable into its embedded shape just before it is embedded, which can be assisted by slightly overclocking the cable feed motor to compress the cable and cause it to bend.

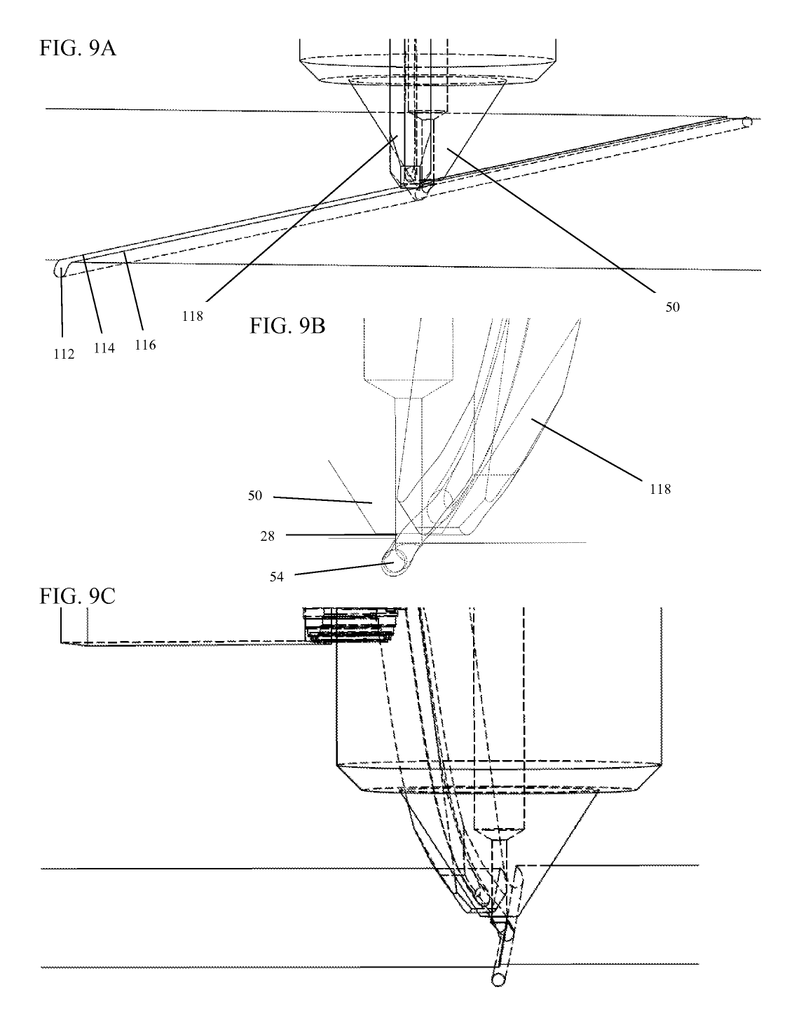

FIG. 9A provides a perspective view of an asymmetrical cable channel (112) with a high side (114) and a low side (116), which is being filled with cable fed by an offset cable guide (118) and embedded by filament from an extrusion nozzle (50).

FIG. 9B provides a side elevation view of FIG. 9A's asymmetrical cable channel to clearly delineate its high and low sides, as well as the cable (54), offset cable guide (118), filament (28), and extrusion nozzle (50).

FIG. 9C provides a perspective view of the asymmetrical cable channel from its closed end.

Asymmetric channeling can be integrated in select areas of regular channels, such as bends or sharp turns. In the case of cable being fed by tension, or through a non-rotatable cable guide, cable hooks (discussed below) and asymmetric channeling can provide distinct advantages in preventing cable excursion and ensuring accurate cable placement, often augmented by using a split-height channel, and placing the channel's high side on the inside of a bend or turn.

When embedded cable is desired in all structures printed with a particular type of filament, the cable may be embedded in the filament during the filament manufacturing process. This presents limitations not present in other embodiments, although it may be more easily implemented in existing 3D printers as long as a cutting mechanism is added or the cable used is weak enough for the print head to sever.

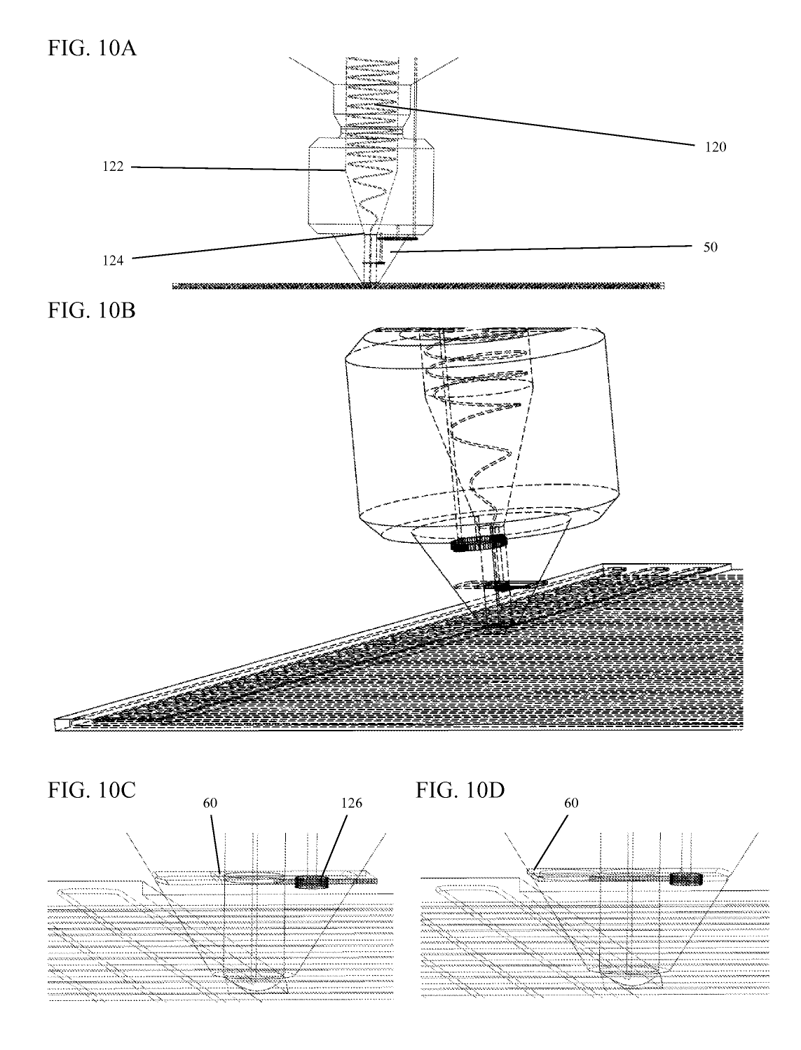

FIG. 10A provides a side elevation view of cable-core filament (120) flowing through a tapered extrusion nozzle (50) that reduces a filament diameter (122) to an extrusion diameter (124), wherein the ratio of cable length to filament length in a given segment of cable-core filament is substantially equivalent to the ratio of the cross sectional area at the extrusion nozzle's filament diameter (122) to the cross sectional area at the extrusion diameter (124).

FIG. 10B provides a perspective view of the extrusion nozzle and object being printed.

FIG. 10C provides a close-up perspective view of the lower extrusion nozzle's cutting shear (60) and its drive gear (126) in the open position.

FIG. 10D provides a close-up perspective view of the lower extrusion nozzle's cutting shear (60) in the cutting position.

When a rotatable print head is desired but perpetual rotation capability isn't required, mechanically simpler solutions such as a non-perpetually rotatable head and remote cable spool may provide a lower cost way to enable most embedded cable applications.

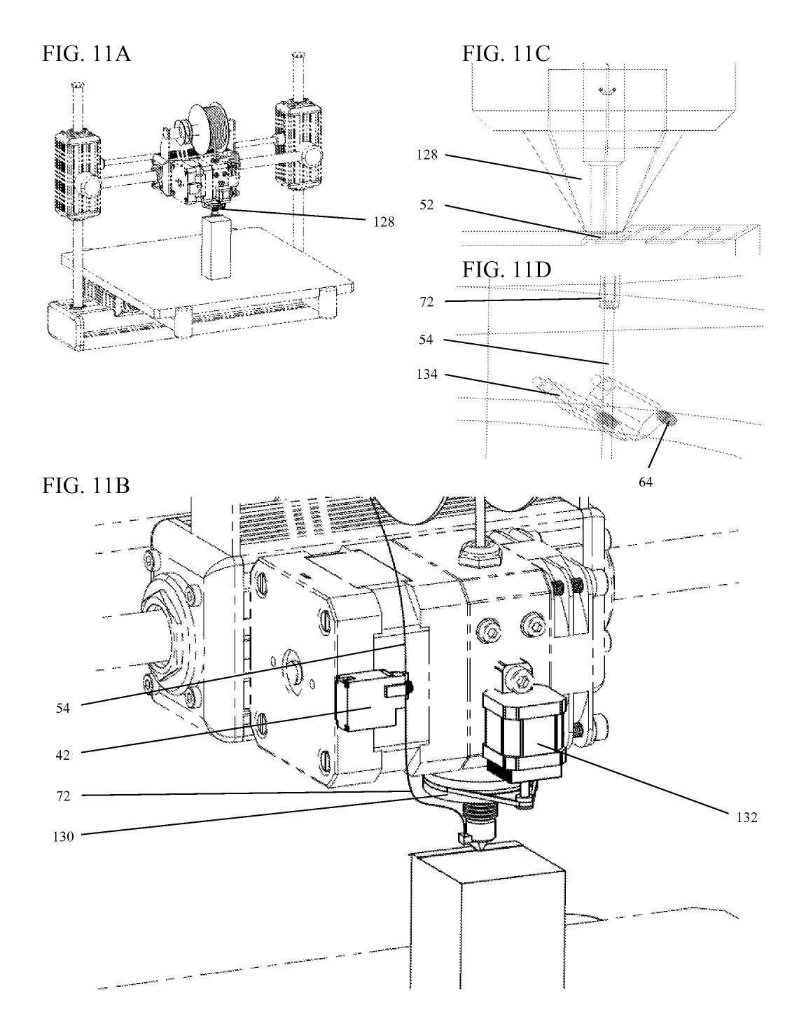

FIG. 11A provides a perspective view of a rotatable cable and filament head (128) printing an object with embedded cable.

FIG. 11B provides a close-up perspective view of FIG. 11A's rotatable cable and filament head and its supporting hardware including the rotatable carrier frame (130) to which it is mounted, cable (54), a cable feed motor (42), conduit (72), and a head-rotating motor (132).

FIG. 11C provides side elevation view of the rotatable cable and filament head (128) forming an embedded piece of cable (52) in a single layer of filament on the object being printed.

FIG. 11D provides a close-up perspective view of the integrated tension shears (134) used in this rotatable cable and filament head, which are actuated by retracting the cable (54) through its conduit (72) with the cable feed motor. Under normal conditions, the tension shears are kept in contact with the cable by torsion springs (64). Although this embodiment extrudes filament and cable in the same direction, the cable guide can be oriented to feed cable in any direction, and any type of cutter may be used.

Cable scaffolding can also be formed to provide a material improvement over prior art scaffolding techniques, which often entail printing several hundred layers of filament scaffolding, printing a desired structure on top of the scaffolding, removing the scaffolding from the desired structure, and throwing it away.

FIG. 12A provides a perspective view of a rotatable cable and filament head (128) printing a layer of filament onto a layer of cable scaffolding.

FIG. 12B provides a close-up perspective view of a rotatable cable and filament head (128) forming a hollow closed structure from a layer of filament being extruded onto a layer of cable scaffolding (136) to form a flat top (138) perpendicular to the hollow object's walls without filament scaffolding.

FIG. 12C provides a perspective view of the scaffolding depicted in FIGS. 12A-B with hidden lines added to show the cable turns (140) embedded in widened platforms formed from inward-tapered layers of filament (142) on two of the object's narrow walls, forming a large enough build platform to embed cable turns of sufficient strength to withstand the tension resulting from the embedding process, weight of the cable, and weight of the filament extruded upon it, in view of the cable used and method of embedding selected.

When tighter cable scaffolding is desired, e.g., to reduce the risk of filament fall-through presented by small extrusion nozzles or slow-to-solidify filament, multiple layers of cable can be embedded with a single bead of filament, although this cable density is often unnecessary.

FIG. 13A provides a perspective view of a cable and filament head stretching a single piece of cable (54) around printed hooks (144) to form cable turns (140) while extruding little or no filament, thus preserving the ability to make multiple cable turns around any given hook. Individual hooks may vary in height to accommodate varying numbers of cable turns and different cable guides, which may be accomplished by making them taller or forming a horseshoe-shaped channels around their bases. In the scaffolding web depicted in FIG. 13A, it may be desirable to stretch additional cable runs obliquely to the lower left edge (146) of the object being printed to increase the density of the web, e.g., by stretching cable from the first hook (148) to the fifty-third hook (150), although similar density and greater uniformity could be achieved in the first instance by increasing the consistency and density of hook distribution around the object's perimeter.

FIG. 13B provides a close-up perspective view of one corner of the object depicted in FIG. 13A.

There are several additional methods for mitigating the possibility of filament drooping or falling through a web of cable scaffolding that warrant mention including extruding filament onto the cable being stretched to increase its surface area, lowering filament temperature, decreasing bead thickness to expedite solidification, increasing the distance between the extrusion nozzle and layer being printed on cable scaffolding to allow air cooling and partial solidification of extruded filament before coming into contact with the scaffolding, forming multiple layers of scaffolding, using cable tension to feed cable, embedding cable in the layer covering the scaffolding, and stretching cable at different angles. Scaffolding need not be horizontal or planar, e.g., cable can be overfed to create a layer with a concave droop and scaffolding can be constructed with any of the cable embedding methods disclosed, without limitation including cable turns formed with cable channels, asymmetric cable channels, hooks, and drop shear cable guides.

When continuity is desired between separate lengths of cable at different levels, conductive paths may be formed with extruded solder, which may be of the conventional variety or a type designed to function as conductive filament, some types being referred to as conductive ink.

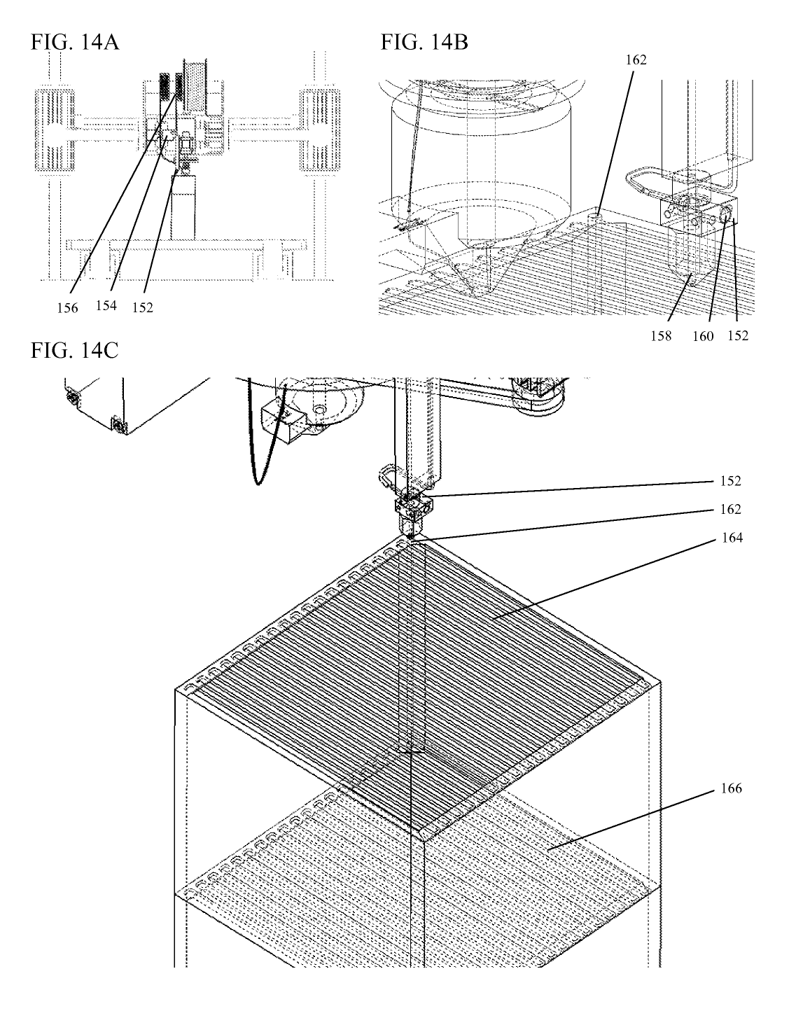

FIG. 14A provides a side elevation view of a printer equipped with a solder extruding head (152), solder feed motor (154), and solder spool (156).

FIG. 14B provides a close-up perspective view of the solder extruding head (152) with a solder extrusion nozzle (158) and heating element (160), capable of extruding molten solder into a hollow continuity channel (162) which ultimately provides a path by which connections to and between cables can be established.

FIG. 14C provides a close-up perspective view of a solder extrusion head (152) positioned at the top of a hollow continuity channel (162) where it will extrude solder downward to connect a first piece of conductive cable (164) to a second piece of conductive cable (166), both of which have an end protruding into the continuity channel. In the event that a retractable solder-extruding head is desirable, any disclosed method of nozzle retraction may be used, along with any other methods apparent to persons of ordinary skill in the art. Finally, the method of establishing connections to or between cable with continuity channels need not involve solder or electrically conductive materials. For example, if a hollow core cable is embedded in the object for the purpose of ventilation or transportation of other fluids, similar results can be achieved without the solder-extruding hardware.

In many applications, such as those where embedded cable is desired in a single layer, cable and filament may be combined before exiting the print head.

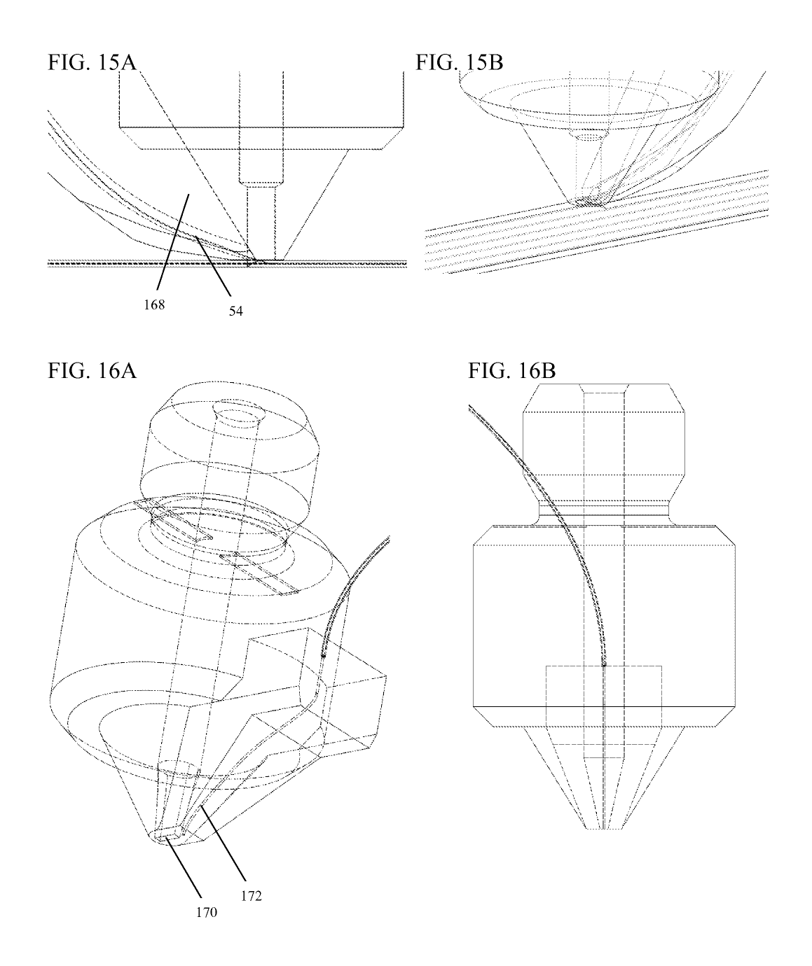

FIG. 15A provides a side elevation view of a pre-extrusion cable-filament combining head (168) with hidden lines showing the location of the cable (54) as it is being fed into the filament extrusion nozzle before being extruded as a cable-filament combination into a single layer of the object being printed.

FIG. 15B provides a perspective view of the object and pre-extrusion cable-filament combining head of FIG. 15A.

For applications demanding large filament structures with low print times and high resolution, variable width filament extrusion nozzles present distinct advantages which are most pronounced when rotatably mounted.

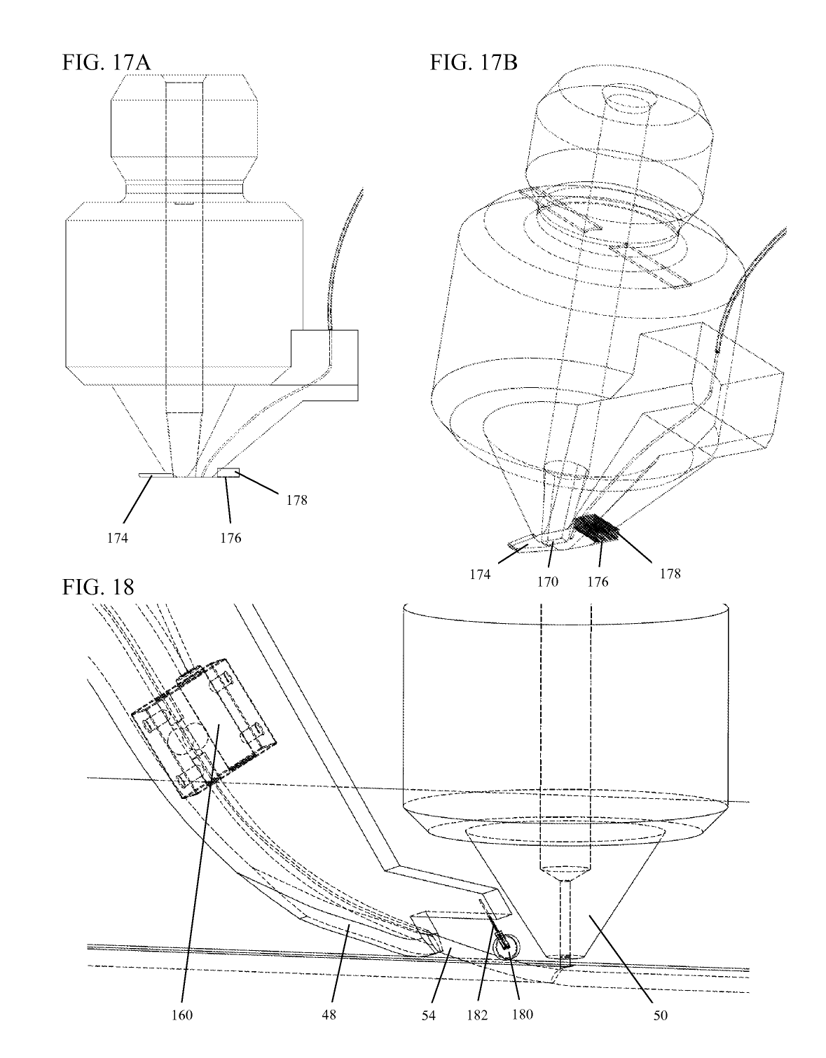

FIG. 16A provides a perspective view of a semi-rotatable cable and filament head with a variable width extrusion nozzle (170) and integrated cable guide (172).

FIG. 16B provides a side elevation view of FIG. 16A's semi-rotatable cable and filament head.

When rotatably mounted to a print head, variable width extrusion nozzles retain the ability to print their entire range of bead shapes in all directions, including the ability to print the narrowest beads and thus its highest possible resolution in all directions. This decreases layer print time and allows some cable channels to be filled in less time with a higher degree of consistency. Furthermore, variable width nozzles' ability to print wide, shallow ribbons of filament with a large surface area promotes rapid filament solidification and reduces the density of cable scaffolding required for reliable cable-filament adhesion. Similarly, variable width nozzles allow more flexible patterns of filament extrusion on top of cable scaffolding, such as the ability to lay wide beads of filament in parallel with their underlying cables to help prevent filament fall-through and layer height oscillation. When the ability to stretch cable scaffolding between narrow ledges is desired and a variable width extrusion nozzle is being used, independently rotatable cable guides such as the one depicted by FIGS. 1A-E may be desirable in view of their ability to form hairpin cable turns without rotating the filament extrusion nozzle. Finally, variable width extrusion nozzles overcome one of the biggest known encumbrances to precise additive manufacturing that is best explained by example. In the event a 10 millimeter wide, and 50 millimeter long object is desired, and a round 4 millimeter extrusion nozzle is used, this is generally accomplished in one of three ways: leaving a 2 millimeter air gap, permitting extensive overlap between the beads of filament in a single layer, or rounding the desired width to a multiple of the extrusion nozzle's diameter (e.g., 8 millimeters). All of these stopgap measures stem from the fact that 4 is not a factor of 10. The same object could be printed to specification and without sacrificing quality with a rotatably mounted variable width extrusion nozzle having, e.g., a rectangular 4 millimeter by 1.5 millimeter outlet, and using it to extrude two 4 millimeter wide beads, and one 2 millimeter bead, the latter accomplished by simply rotating the nozzle ˜82.6 degrees in either direction from its 4 millimeter extrusion position.

It may be desirable to use a filament extrusion nozzle with pressure plates protruding horizontally from the bottom of the nozzle to seal the portion of an open cable channel around the nozzle, enabling higher pressure extrusion and deeper, more consistent filament penetration. This provides a distinct advantage in configurations that require a larger than normal distance between the extrusion nozzle's tip and the surface onto which it is extruding filament, such as the bottom of an open cable channel.

FIG. 17A provides a side elevation view of a cable-filament combining head with a forward pressure plate (174) and an afterward pressure plate (176) containing a heat sink (178).

FIG. 17B provides a perspective view of a cable-filament combining head with a forward pressure plate (174), variable width extrusion nozzle (170), and afterward pressure plate (176) with a heat sink (178) to facilitate rapid solidification when molten filaments are used. Regardless of the type of filament being used, the use of both types of plates in conjunction with one another help prevent filament excursion from its target destination (e.g., a cable channel) and ensure a smooth finish.

In some applications, cable-filament adhesion is enabled or augmented by heating the cable as it is fed into the object being printed.

FIG. 18 provides a perspective view of a filament extrusion nozzle (50) embedding a piece of cable (54) that is being extruded from a cable guide (48) equipped with a spline roller (180) which applies downward pressure on the cable, assisted by a spline spring (182) providing a number of advantages including the ability to press cable below grade to achieve stronger cable-filament adhesion and more consistent cable placement without changing the cable feed direction or lowering the cable guide. The cable guide can also be equipped with a heating element (160) that heats the cable being fed for any reason, such as promoting better cable-filament adhesion and enabling solidified thermoplastic penetration.

Sprag clutches may be implemented to feed cable, actuate cable cutters, deploy cable cutters, and controllably drive other parts of the invention.

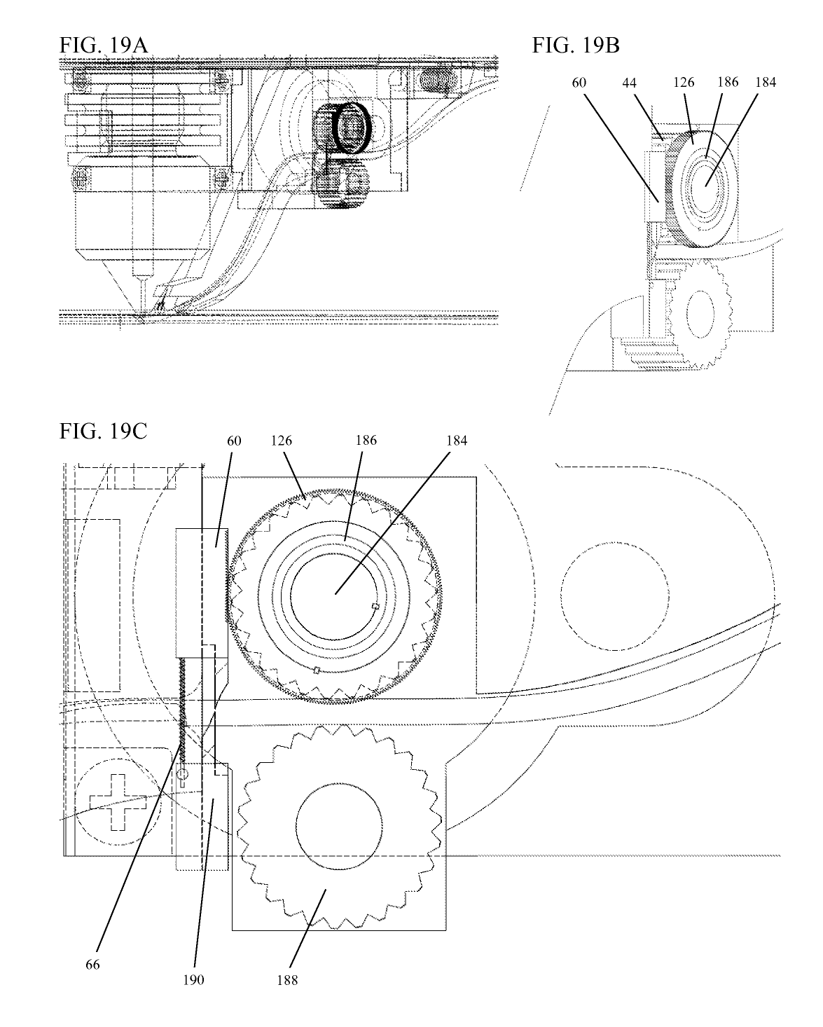

FIG. 19A shows a coaxial sprag clutch cutter assembly integrated into a cable head.

FIG. 19B provides a close-up perspective view of the coaxial sprag clutch cutter assembly of FIG. 19A that functions similarly to the ratchet cutter assembly of FIG. 1E, distinguished by coaxial sprag clutches stacked in opposition to one another on the cable feed motor's driveshaft (184) such that the cable sprag clutch inside the cable drive gear (44) is engaged only when the cable feed motor's driveshaft (184) is rotated clockwise, and the cutter sprag clutch (186) engages a shear drive gear (126) in communication with a cutting shear (60) only when the cable feed motor's driveshaft is rotated counter-clockwise, causing the cutting blade to sever the cable that remains stationary due to the cable sprag clutch's propensity to slip under counter-clockwise loads.

FIG. 19C provides a close-up side elevation view of the sprag cutter assembly of FIGS. 19A-B including the cable drive gear (188), cable feed motor's driveshaft (184), stationary cutting shear (190), moveable cutting shear (60), cutter sprag clutch (186), shear drive gear (126), and shear-opening spring (66) which returns the moveable cutting blade to the upward position as the cable feed motor's driveshaft resumes clockwise rotation.

Another simple solution for cutting cable involves simply driving a shear attached to the print head through the cable. Although the force required to cut large diameter cable is more likely to require a dedicated cable cutter to avoid compromising a printer's calibration, retractable extrusion nozzles are especially useful where mitigation of cost and complexity are desired.

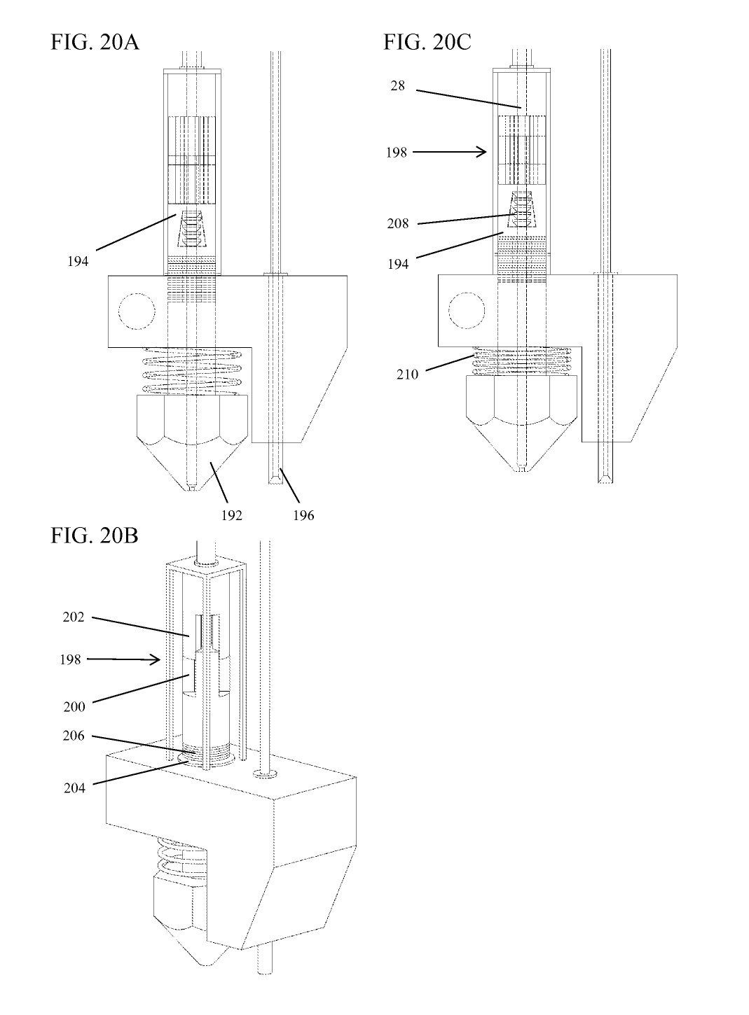

FIG. 20A provides a side elevation view of a semi-rotatable cable and filament head containing a retractable extrusion nozzle (192) attached to an extrusion nozzle shaft (194) in its default extrusion position, in which the extrusion nozzle is maintained below the drop shear cable guide (196).

FIG. 20B provides a perspective view of FIG. 20A to clearly show the section of compressible conduit (198) formed by the lower interlocking fingers (200) protruding from the extrusion nozzle shaft, which slide into the upper interlocking fingers (202) while providing consistent filament sidewall support regardless of the retractable extrusion nozzle's position. FIG. 20B also depicts the extrusion nozzle shaft's stop ring (204) and heat sink (206).

FIG. 20C provides a side elevation view of the hardware from FIGS. 20A-B having applied tension to the filament (28) sufficient to engage the clamping chuck (208) inside the extrusion nozzle shaft (194), compressing the conduit and retractable nozzle spring (210) while lifting the retractable extrusion nozzle above the drop shear cable guide to facilitate the feeding and/or cutting of cable.

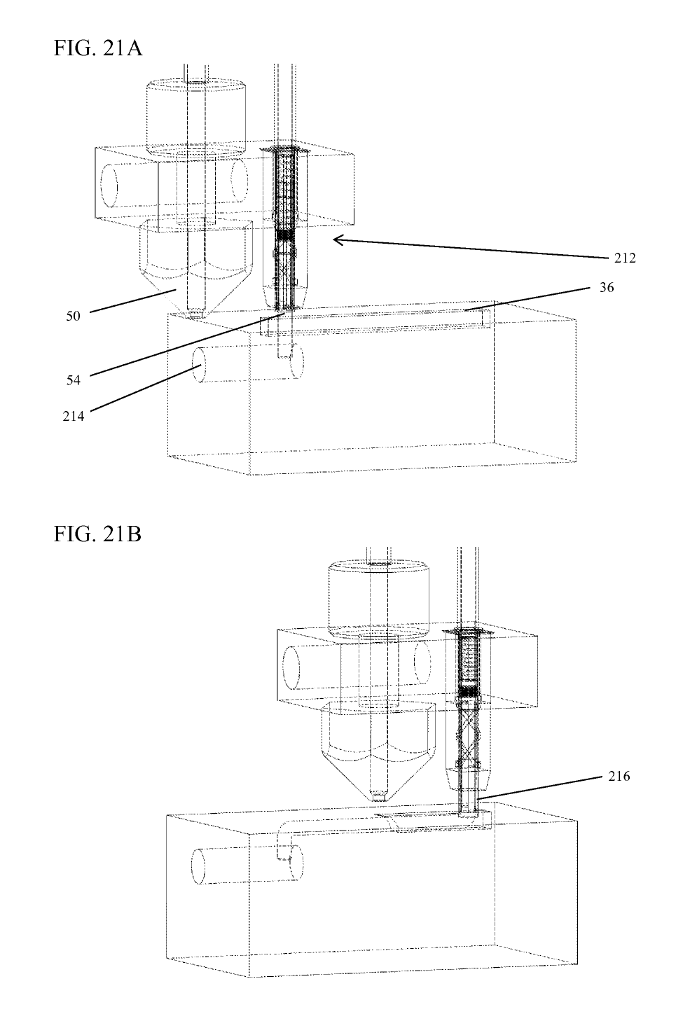

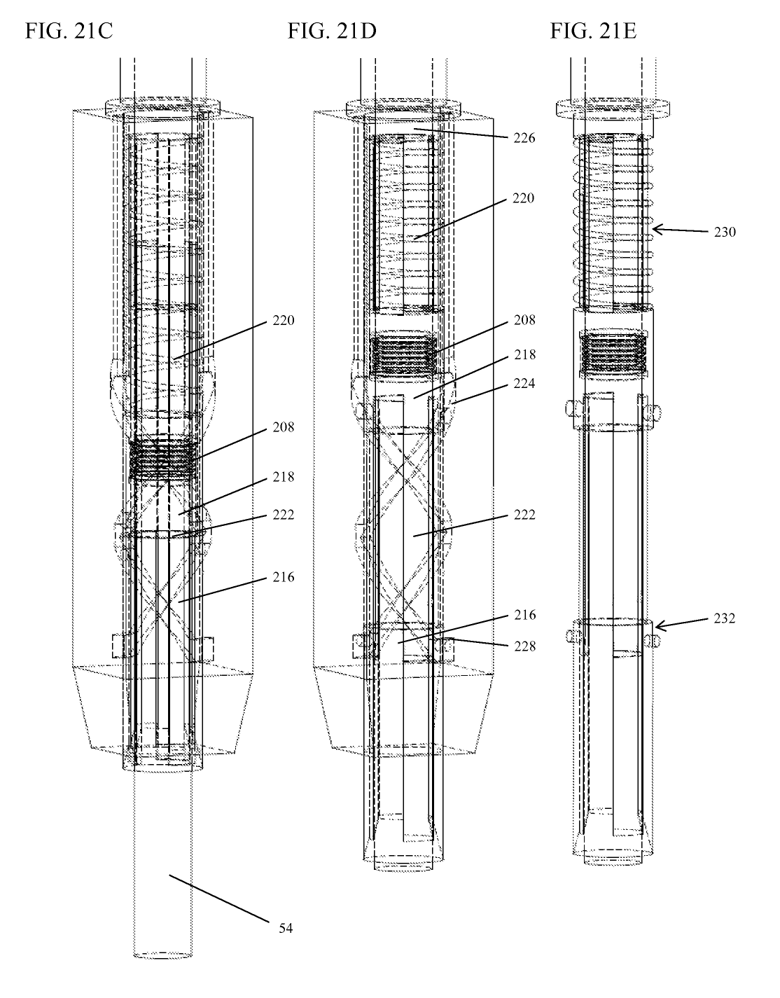

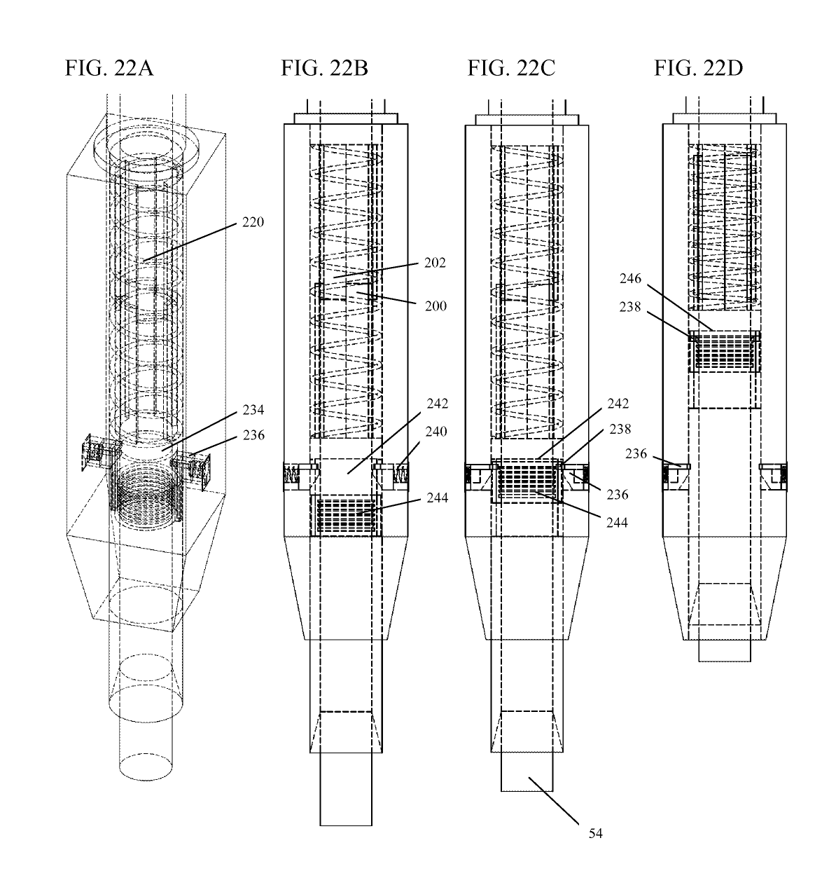

While mechanically simple, retractable extrusion nozzles actuated by clamping chucks are sometimes more difficult to implement on existing printers, especially in view of the low tolerance for unintended extrusion nozzle shifting in additive manufacturing. In view of this difficulty, deployable shears such as the ones depicted by FIGS. 21-22 may be more appropriate.

Finally, it should be noted that, although the tolerances would be tight, similar results can be achieved without moving parts in the print head. This can be accomplished by fixing the cutter at a position below the fixed extrusion nozzle's tip, inside the narrow envelope between it and the layer onto which it is extruding, to allow cutting of small diameter cable without bottoming out the extrusion nozzle. This small diameter limitation can be overcome by leaving nozzle clearance wells in the object being printed to allow cutting of larger wire, or by adopting a mechanism such as the spring mechanism from FIG. 20 when contact between the extrusion nozzle and solidified filament below it will not result in excessive melting.

FIGS. 21A-E provide a detailed depiction of a drop shear cable guide that is deployed by cable tension. FIG. 21A provides a perspective view of a filament and cable print head including a filament extrusion nozzle (50) and drop shear cable guide assembly (212) in the undeployed state as it feeds cable (54) through the bottom of an open cable channel (36) into a cable access cavity (214) of an object being printed.

FIG. 21B provides a perspective view of the hardware depicted in FIG. 21A, having embedded cable into the object throughout the closed portion of the cable channel, and begun the cable cutting process by first applying tension to the cable to deploy its shear sleeve (216), and then reducing the clearance between the print head and the object until the shear sleeve severs the cable.

FIG. 21C provides a close-up perspective view of FIG. 21A's drop shear cable guide assembly in the cable feeding state, during which the clamping chuck (208) rotatably embedded in the clamping sleeve (218) remains disengaged from the cable (54), allowing downward pressure from the compressible conduit spring (220) to hold it in the full downward position, where it is stopped at the point of contact (222) between the clamping sleeve (218) and the lower shear sleeve (216).

FIG. 21D provides a close-up perspective view of the hardware of FIG. 21C, having applied tension to the cable sufficient to bind the clamping chuck (208) to the cable and overcome the downward force imparted by the compressible conduit spring (220), pulling the clamping sleeve (218) upwards through the assembly's rifled housing (224), causing the clamping sleeve to rotate. Because the clamping sleeve's interlocking fingers are mated with the fingers extending downward from the free-rotating upper compressible conduit sleeve (226), and upward from the lower shear sleeve (216), all three sleeves rotate together. This nonetheless causes the clamping and shear sleeves to move in opposite directions as the cable is pulled upwards, because rifled housing's rifling changes direction at the clamping and shear sleeves' point of contact (222). Because the bottom of the rifling (228) is perpendicular to the compressive force generated by cutting cable, both sleeves are prevented from moving during the cutting process.

FIG. 21E provides the close-up view of FIG. 21D, having removed the rifled housing to provide a better view of the top interlocking fingers (230) in the compressed state, and bottom interlocking fingers (232) in the expanded state.

When cable is vertically fed into a solidified portion of a thermoplastic object, the leading end of the cable is generally positioned in close proximity to a heater element to raise its temperature above the filament's melting point before feeding it down to the depth at which the cable is to be embedded, before the cable temperature drops below the filament's melting point. This initial cable feed process often takes place with the heater element in close enough proximity to the object to apply excessive and undesired heat through the cable via convection, which can cause excessive melting. This issue can easily be addressed by simultaneously raising the print head and feeding cable at the same rate once the cable has reached its desired depth. This step is often followed by holding the raised print head in a motionless state until the filament enveloping the cable has solidified and the cable guide has reached a temperature low enough to avoid undesired melting during the remainder of the embedding process. Depending on the selected print speed, target fed cable temperature, and proximity of the cable guide to the heating element, it may be desirable to adjust the print head's temperature or even completely disable the heat source during cable-only print sections, such as the scaffolding depicted in FIGS. 13A-B. Various additional temperature control methodologies such as the use of cooling fans will be apparent to persons of ordinary skill in the art, as will simple changes to these embodiments' mechanism of action. For example, instead of the freely rotatable upper compressible conduit sleeve and clamping chuck depicted in FIG. 21, a ring bearing could be inserted in the clamping sleeve above its lower fingers and below the clamping chuck, eliminating the need for these components' rotation.

Small modifications to the drop shear cable guide assembly of FIGS. 21A-E can enable feeding of cable with the shear sleeve in the downward position. This can enable more precise cable placement and help prevent cable excursion under certain conditions such as winding cable around hooks below the surface of an object.

FIGS. 22A-D provide one method of arranging a drop shear cable guide assembly such that its shear deploys and locks when cable is fed, and retracts with the cable for easy integration into new or existing print heads.

FIG. 22A provides a perspective view of a drop shear cable guide assembly feeding cable. In this state, gravity and/or a compressible conduit spring (220) lower the shear sleeve (234) to its full downward position, where it is locked in place when sleeve latches (236) slide into its sleeve catches.

FIG. 22B provides a side elevation view of FIG. 22A to clearly show the assembly's sleeve latch springs (240) and fixed upper interlocking fingers (202), along with the shear sleeve's lower interlocking fingers (200), sliding clamp cavity (242), and sliding clamp (244), which simply applies drag to the cable being fed through it. This can be a clamping chuck whose teeth bind to the cable only when it is retracted, a friction collar that always applies friction, or any other source of drag. Non-binding methods of drawing off the cable's motion are often used to facilitate easy retraction of cable through the assembly and reliably deploy assemblies that lack a compressible conduit spring or are not mounted vertically. It also may be desirable to select a clamping chuck whose maximum clamping force may be overcome by the cable's tensile strength and/or the feed motor to facilitate easy manual or motorized cable refraction through the assembly.

FIG. 22C provides a side elevation view of the same assembly with the cable (54) having been slightly retracted. This has not caused the shear sleeve to move because its sliding clamp (244) has not yet reached the top of the sliding clamp cavity (242). The sliding clamp has, however, unlocked the shear sleeve by compressing the sleeve latches (236), removing them from the sleeve catches (238).

FIG. 22D provides a side elevation view of the same assembly with the cable having been substantially retracted. This has caused the sliding clamp to pull the shear sleeve up by their point of contact (246) at the top of the sliding clamp cavity. In this state, the shear sleeve's outer walls hold the sleeve latches (236) in the compressed state until they again become aligned with the sleeve catches (238).

When a shared cable and filament heating element is used, it may be desirable to limit direct or indirect contact between the heating element and drop shear cable guide assembly with the exception of a dedicated convection surface on the shear sleeve that contacts a heated surface only in the non-feeding position, the advantage being targeted heating of the cable's end to ensure it is securely embedded, without unnecessarily heating the remainder of the cable.

1. A method of embedding a cable in a 3D printed object comprising:
a) aligning a cable guide with a first point on a predetermined cable path along said 3D printed object,
b) using a motor to feed a first end of said cable through said cable guide to said first point on said predetermined cable path,
c) embedding said first end of said cable at said first point of said predetermined cable path in a filament extruded through an extrusion nozzle,
d) moving said cable guide along said predetermined cable path while feeding said cable through said cable guide and extruding said filament through said extrusion nozzle onto said predetermined cable path to embed said cable along said predetermined cable path to a second point on said predetermined cable path, and
e) severing the portion of said cable allocated to said predetermined cable path from any unallocated portion of said cable.

2. The cable guide of claim 1 wherein said cable guide is rotatably mounted in communication with a cable guide motor and means for controllably coupling rotational energy between said cable guide and said cable guide motor.

3. The cable guide of claim 2 further comprising a spool of cable and means for perpetually rotating said cable guide and said spool of cable.

4. The method of claim 1 further comprising construction of a cable channel along said predetermined cable path with means for securing said cable within said cable channel.

5. The cable channel of claim 4 wherein said means for securing said cable within said cable channel are selected from a group consisting of channel notches, pressure plates, ribs, flares, tapered indents, and combinations of the foregoing.

6. The cable feeding process of claim 1 wherein said cable is fed at an overclocked rate to create compressive stress within said cable, whereby said compressive stress causes said cable to bend, buckle, or penetrate existing layers of filament.

7. The cable feeding process of claim 1 further comprising heating of said cable.

8. The method of claim 1 wherein two or more solidified filament edges are separated by an open area, and said cable is embedded in a first edge and pulled across said open area to a second edge, whereby said cable's tensile strength and said first and second edges support at least one hanging cable run over said open area.

9. The method of claim 8 wherein a layer of cable scaffolding is formed from a plurality of said hanging cable runs.

10. The method of claim 1 further comprising construction of at least one cable hook along said predetermined cable path, whereby said cable hook prevents cable displacement from said predetermined cable path.

11. The cable of claim 1 wherein said cable embedded within said 3D printed object is electrically conductive and forms a circuit.

12. The method of claim 1 wherein said filament is used to form a hollow continuity channel around said cable within said 3D printed object, whereby said hollow continuity channel is used to establish a connection to said cable.

13. The method of claim 1 further comprising extruding additional filament onto said cable and said predetermined cable path between said first point on said predetermined cable path and said second point on said predetermined cable path.

14. A method of embedding cable within a cable channel comprising:
a) using a filament extrusion nozzle to construct an open cable channel along a predetermined cable path on the surface of an object being printed with means for securing unembedded cable within said cable channel,
b) pausing the printing of said object until the process of feeding said cable into said open cable channel is completed by a user and said user provides computer input indicating the cable feeding process is complete, and
c) resuming the printing process and extruding a sufficient amount of filament onto and around said cable to embed said cable along said predetermined cable path.

15. A computer-controlled cable embedding 3D print system comprising:
a) a filament feed motor,
b) a filament extrusion nozzle,
c) a cable cutter, and
d) a cable guide capable of controllably feeding a cable into a predetermined cable path.

16. The computer-controlled cable embedding 3D print system of claim 15 wherein said filament extrusion nozzle is retractable.

17. The filament extrusion nozzle of claim 15 wherein said filament extrusion nozzle is a rotatably mounted variable width extrusion nozzle in communication with a motor capable of dynamically adjusting the angular position of the extrusion nozzle to provide the desired filament extrusion width regardless of the extrusion nozzle's direction of travel.

18. The cable feeding system of claim 15 further comprising, in combination, a cable feed motor and means for actuating said cable cutter by reversing the direction of said cable feed motor.

19. The cable feeding system of claim 15 further comprising, in combination, a cable feed motor and means for deploying said cable cutter by reversing the direction of said cable feed motor.

20. The 3d print system of claim 15 wherein said cable cutter is driven through said cable by sandwiching said cable between said cable cutter and an object being printed.

21. The cable embedding system of claim 15 wherein said combined cable and filament head combines said cable and said filament before extruding said cable and said filament as a cable-filament combination.
